(19) United States
(12) Patent Application Publication
(10) Pub. No.: US 2017/0238748 A1
(43) Pub. Date: Aug. 24, 2017

(54) DISPOSABLE BOX FOR COOKING AND TRANSPORTING A PREPARED FOOD PRODUCT, AND NOTABLY A PIZZA

(71) Applicant: ADIAL, Lisieux (FR)

(72) Inventor: Ludovic LORILLARD, Cuverville (FR)

(21) Appl. No.: 15/424,907

(22) Filed: Feb. 6, 2017

(30) Foreign Application Priority Data
Feb. 18, 2016 (FR) 1651330

(51) Int. Cl. A47J 27/00; B65D 5/50; B65D 5/64; B65D 5/42

(52) U.S. Cl. CPC A47J 27/002; B65D 5/4295; B65D 5/4266; B65D 5/5028; B65D 5/64

(57) ABSTRACT

Disclosed is a disposable box for cooking and transporting a prepared food product, and notably a pizza, which includes a plane horizontal bottom having at least one opening passing through it, a vertical side panel that extends upward around all of the periphery of the bottom, and a horizontal, rigid cooking support plate that rests on the bottom. The cooking support plate has at least one hole passing through it with a vertical orientation. At least one solid portion of the cooking support plate is arranged facing the opening in the bottom.

### TECHNICAL FIELD OF THE INVENTION

The present invention concerns a disposable box for cooking and transporting a food product.

The present invention more particularly concerns a disposable box for cooking and transporting a prepared food to product, and notably a pizza, which has a plane horizontal bottom having at least one opening passing through it, a vertical side panel that extends upward around all of the periphery of the bottom, and a horizontal, rigid cooking support plate that rests on the bottom.

### PRIOR ART

Food products prepared in advance are distributed in two forms: cooked, ready to eat, and raw, ready to cook. This is notably the case for pizzas.

Some consumers prefer to cook their pizza in their home in their oven so as to be able to eat it while still hot.

Traditional ovens, as found in private homes, are generally equipped with a standard cooking shelf, made up of bars, and flat metal baking sheets.

These cooking shelves with wide gaps between the bars are not suitable for supporting the preparations directly, especially pizzas which are deformed in said gaps.

Baking sheets are suitable for supporting preparations such as pizzas, but their plane metal surface has the effect of insulating the underside of the pizza. Cooking is then not uniform and in particular there is no crust distributed across the surface of the pizza in contact with the baking sheet.

Other consumers prefer to purchase a cooked and still hot pizza that can be eaten anywhere as soon as it is purchased.

There are known to exist pizza dispensers able to supply cooked and hot pizzas.

These dispensers are equipped with a storage unit for storing prepared pizzas and means for cooking pizzas.

The pizzas may be stored in the storage unit in boxes. After the customer orders and pays, the box is fed to the pizza cooking means. The pizza is extracted automatically from its box to be cooked optimally and is then replaced in the box while still hot.

Customers then receive a box containing their cooked and transportable pizza. The box used by the dispensers must be compatible with the means of movement between the various compartments of the dispensers.

These boxes must also be adapted to suit the temperature conditions that they encounter, notably in the cooking compartment.

In all cases, pizzas are sold in boxes enabling them to be transported to the place of consumption.

To reduce manufacturing costs and so as not to encumber the consumer when they have finished eating, the boxes must be disposable and for single use.

There are known to exist pizza dispensers able to supply both cooked, hot pizzas and prepared, cold pizzas at the choice of the consumer.

The object of the invention is to propose a box that retains all the aforementioned features and solves the problems that have been referred to.

The object of the invention is notably to propose a box for transporting and cooking a pizza suitable for an automatic pizza dispenser that makes it possible to optimize the cooking of a pizza both in the oven of the automatic dispenser and in a conventional oven.

### SUMMARY OF THE INVENTION

The invention proposes a disposable box for cooking and transporting a prepared food product, and notably a pizza, which includes: a plane horizontal bottom having at least one opening passing through it, a vertical side panel that extends upward around all of the periphery of the bottom, and a horizontal, rigid cooking support plate that rests on the bottom, characterized in to that the cooking support plate has at least one hole passing through it with a vertical orientation and in that at least one solid portion of the cooking support plate is arranged facing the opening in the bottom.

This notably makes it possible to move the pizza upward out is of the box by means of vertical movement actuator fingers that pass through the holes and act on a solid part of the plate.

According to other features of the invention:
at least one solid portion of the support plate faces the opening in the bottom regardless of the angular position of the support plate relative to the bottom;
the box includes means for angularly positioning the support plate relative to the bottom;
the angular positioning means comprise complementary surfaces of the support plate and the side panel;
at least one solid portion of the support plate faces the whole of the opening in the bottom;
the support plate includes a plurality of holes;
the holes in the plate are different sizes.

### BRIEF DESCRIPTION OF THE DRAWINGS

Other features and advantages of the invention will become apparent on reading the following detailed description, for an understanding of which reference should be made to the appended drawings, in which:

FIG. 1 is an exploded view of a disposable box according to the teachings of a first embodiment of the invention;

FIG. 2 is a view of the invention in section on a plane A to from FIG. 1;

FIG. 3 is a top view of a cooking support plate of a box as shown in FIG. 1;

FIG. 4 is a view similar to that of FIG. 3 of a second embodiment of the invention;

FIG. 5 is a view similar to that of FIG. 3 of a third embodiment of the invention.

### DETAILED DESCRIPTION OF THE DRAWINGS

In the remainder of the description, elements having an identical structure and/or analogous functions are designated by the same reference.

In the remainder of the description there will be adopted by nonlimiting convention, longitudinal, vertical and transverse orientations indicated in the figures by the trihedron L,V,T.

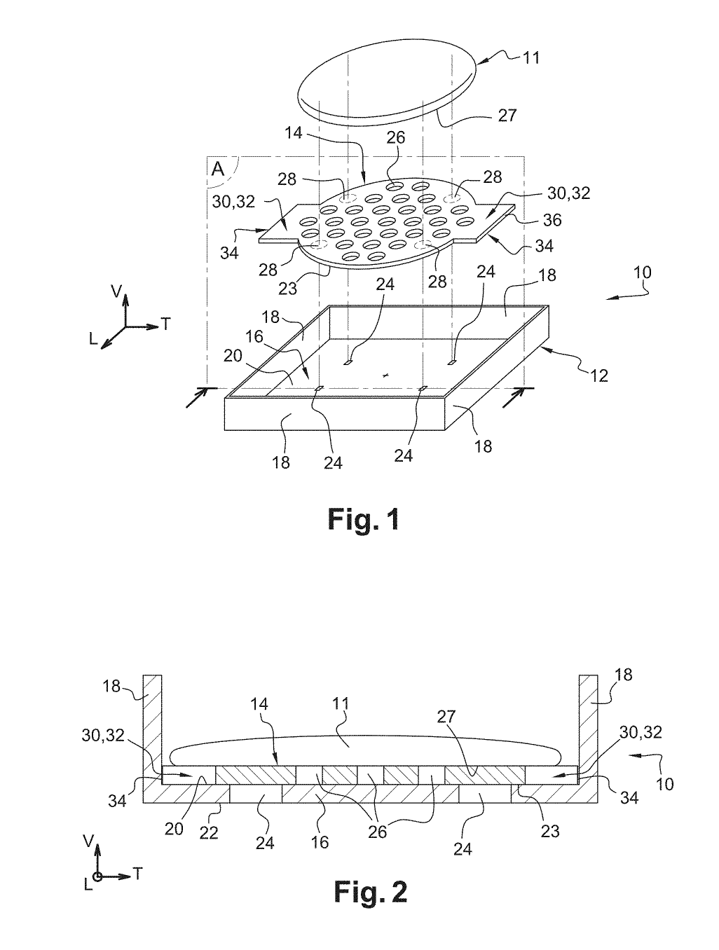

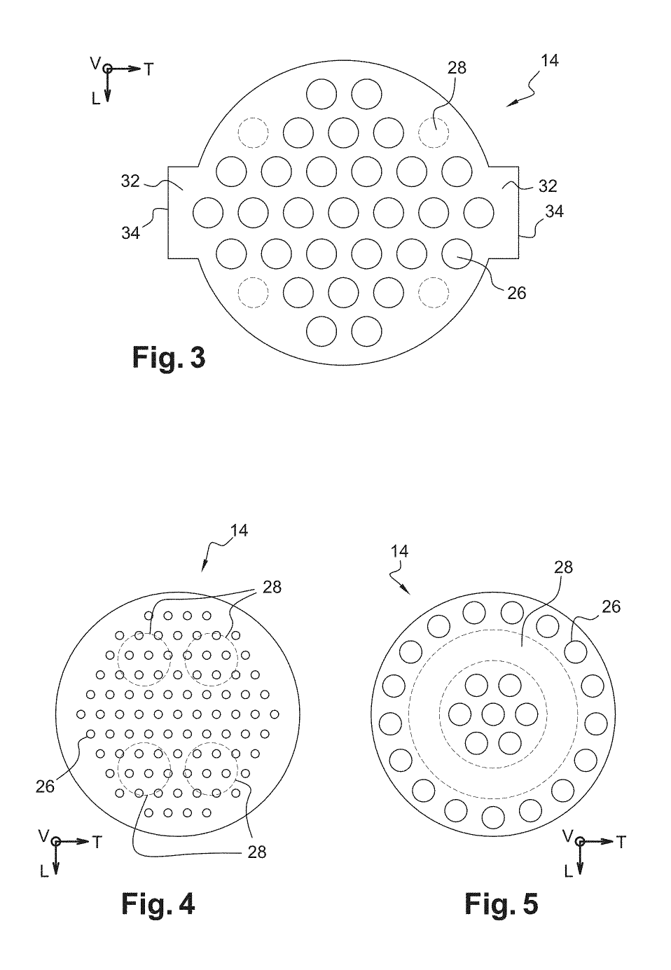

In FIG. 1 there is shown a box 10 according to a first embodiment of the invention for cooking and transporting a pizza. The box includes packaging 12 and a cooking support plate 14.

The cooking support plate 14 and the pizza 11 are intended to be housed in the packaging 12.

The packaging 12 includes a square horizontal plane bottom 16 and four side panels 18. The panels 18 extend vertically upward around all of the periphery of the bottom 16.

According to a variant that is not shown, the bottom is a disk just like the cooking support plate. A single panel delimits the perimeter of the bottom.

The packaging 12 is made from a disposable material adapted to retain its shape and its stiffness when heated in a conventional oven, at between 200° C. and 300° C., for the time to necessary to cook a pizza, for example 10 minutes.

The packaging 12 must also be sufficiently rigid to make it possible to transport the pizza 11 when held in the bare hands without becoming deformed. The packaging 12 is made of cardboard, for example.

The bottom 16 of the packaging 12 is intended to support the support plate 14 and the pizza 11.

The bottom 16 of the packaging 12 is a plate the size and the shape of which are greater than those of the pizza 11. Here the bottom 16 is substantially square. The bottom 16 has an upper face 20 and a lower face 22. The upper face 20 is in contact with the lower face of the plate 14.

The bottom 16 also has four identical openings 24 passing through it. The openings 24 are substantially square and pass vertically through the bottom 16. The openings 24 are disposed symmetrically relative to the centre of the bottom 16. Here the openings 24 are disposed in a pattern inscribed within a circle.

The side panels 18 are fixed to the perimeter of the bottom 16. The side panels 18 are made from the same material as the bottom 16. This makes it possible to simplify the production of the box 10 by cutting and folding.

The panels 18 extend vertically upward from the bottom 16. The vertical height of the panels 18 is defined so as to extend above the pizza 11 when the latter is placed in the box.

The side panels 18 are interconnected by conventional fixing means (not shown), for example glue. The panels 18 close the perimeter of the box 10.

The panels 18 are sufficiently rigid to withstand the weight of a lid (not shown).

According to a variant that is not shown the panels are connected to a retractable lid.

The cooking support plate 14 rests on the bottom 16. The plate 14 is plane and rigid and its shape is substantially that of a to disk with a diameter adapted to support the pizza 11.

The cooking support plate 14 is made from a material that, among other criteria, meets the requirements of European hygiene standards, for example the Reach standard. Moreover, this material must be able to retain all its physical properties at is temperatures between 100° C. and 300° C.

The plate 14 is for single use, and therefore for cooking a single pizza. The durability of the plate 14 is limited to that use.

For example, the plate 14 is made from the following materials: corrugated cardboard made of cooking paper or food-grade paper, compressed cardboard, baking parchment, biodegradable materials such as plant pulp or wood.

The dimensions of the plate 14 enable it to be easily inserted in and/or extracted from the packaging 12.

The dimensions of the plate 14 are advantageously less than those of the bottom 16 of the packaging 12. In this way the plate 14 can be placed on the bottom 16 without coming into contact with the side panels 18.

The dimensions of the plate 14 are adapted to support the pizza 11 both when raw and when cooked. The plate 14 is adapted to support the raw pizza 11 with little deformation of the pizza 11 that remains acceptable so as to produce a cooked pizza substantially in the form of a disk.

The plate 14 also has a plurality of ventilation holes 26 passing through it. The ventilation holes 26 mean that a part of the pizza 11 is exposed to the air while cooking. The pizza 11 therefore cooks with a better distributed crust on its lower face.

The dimensions of the holes 26 are defined to optimize the cooking of the pizza 11. Here the holes 26 are circular cylinders with a vertical axis. The dimensions of the holes 26 must also make it possible to limit the deformation of the pizza 11 through the holes 26 when it is resting on the cooking support plate 14.

According to the first embodiment, the holes 26 are all identical and occupy the surface of the plate 14 in a non-uniform manner in a quincunx pattern.

According to a variant that is not shown, the holes 26 have different diameters according to a preferred distribution of the is cooking action.

The plate 14 also has a surface that delimits an area 28 facing the openings. When the plate 14 is resting on the bottom 16 of the packaging 12, the area 28 is arranged facing the openings 24 in the bottom 16.

Here, the facing area 28 is inscribed within a centred ring. The facing area 28 is a solid portion of the plate 14 and therefore does not include any holes 26.

The box 10 also includes means 30 for angularly positioning the cooking support plate 14 relative to the bottom 16. The angular positioning means 30 make it possible to position the area 28 facing the openings 24 in the bottom.

Here the plate 14 includes angular positioning means 30 of complementary shape to the side panels 18 of the packaging 12.

Here the positioning means 30 comprise two radial lugs 26 that extend outward from the disk of the plate 14. Each lug 26 has one edge connected to the plate 14 and a free outer edge 32. The outer edge 32 includes a plane face 34 complementary to and adjacent the vertical panels 18.

There are two ways to use the box 10.

The first way is for the box 10 to be used to transport a raw pizza 11, for example between a pizza dispenser and a home. The stiffness of the box 10 makes it possible to protect the pizza 11 during transportation.

Once the box 10 has been delivered to the home, the pizza and the cooking support plate 14 are removed from the packaging 12 with bare hands to be inserted in a conventional oven.

Ideally the pizza 11 and the plate 14 are removed from the packaging 12 simultaneously. The pizza 11 rests on the cooking support plate 14 as they are moved toward the oven.

The plate 14 supports the pizza 11 during cooking. The holes 26 in the cooking support plate 14 enable the bottom of the is pizza 11 to be exposed to the air and better distribution of heat around the pizza 11. This results in more appropriate cooking that offers a crust distributed over a more uniform surface than with a standard baking sheet without holes.

Once cooking has finished, the cooked pizza 11 and the plate 14 are removed from the oven. The wear of the plate 14 and/or its possible absorption of liquids from the pizza 11 mean that it cannot be used again for further cooking. The cooking support plate 14 can be discarded with recyclable domestic waste.

The second way is to use the box 10 for cooking a pizza 11 in a cooking device of an automatic pizza dispenser (not shown).

During movement of the box 10 to the cooking device, the positioning means 30 maintain the angular position of the plate 14 relative to the packaging 12.

In the cooking device, the cooking support plate 14 is raised vertically out of the packaging and optionally transferred to an oven.

The vertical movement is performed by rods or fingers of smaller section than the openings 24. The rods pass through the openings 24 in the bottom of the packaging 12 and come to bear against the solid part of the plate 14 facing each opening 24 so as to push the plate 14 vertically upward out of the packaging 12.

The positioning of the cooking support plate 14 makes it possible to ensure a corresponding relationship between the openings 24 in the bottom 16 and the facing area 28 of the cooking support plate 14.

The plate 14 supporting the pizza 11 is raised in the oven throughout the time to cook the pizza 11.

Cooking the pizza 11 on its support plate 14 has the same advantages and produces the same quality as before.

Once cooking has finished, the plate 14 is lowered and replaced in the packaging 12.

The box 10 containing the cooked pizza 11 is then delivered is to the customer. After eating the pizza 11 the box 10 may be discarded with recyclable domestic waste.

A second embodiment is described with reference to FIG. 4 by comparison with the first embodiment.

According to the second embodiment, the box 10 is similar to that described in relation to the first embodiment except for the cooking support plate 14 and the positioning means 30.

The cooking support plate 14 includes a plurality of identical holes 26 and a facing area 28.

The facing area 28 is an annular strip of material. The width of the strip is at least able to cover completely an opening 24 in the bottom 16.

The area 28 therefore faces the openings 24 in the bottom 16 whatever the angular position of the plate 14 and the bottom 16.

In this embodiment, the box 10 therefore includes known means 30 for positioning the plate 14 relative to the packaging 12.

A third embodiment is described with reference to FIG. 5 by comparison with the second embodiment.

According to the third embodiment, the box 10 is similar to that described in relation to the second embodiment except for the cooking support plate 14.

The cooking support plate 14 includes a plurality of holes 26. The holes 26 are smaller than the openings 24 in the bottom 16.

In this way, even if the holes 26 are arranged facing the openings 24 in the bottom 16, a solid portion of the plate 14 is also arranged facing the openings 24.

In this embodiment, the box 10 does not include a specific area 28 facing the openings 24.

According to a variant that is not shown, the cooking support plate includes small holes on an annular strip. The width of the strip is at least able to cover completely an opening in the bottom.

Larger holes pass through the rest of the plate.

1. Disposable box for cooking and transporting a prepared food product, and notably a pizza, which includes:
a. a plane horizontal bottom having at least one opening passing through it;
b. a vertical side panel that extends upward around all of the periphery of the bottom; and
c. a horizontal, rigid cooking support plate that rests on the bottom;
wherein the cooking support plate has at least one hole passing through it with a vertical orientation and wherein at least one solid portion of the cooking support plate is arranged facing the opening in the bottom.

2. Box according to claim 1, wherein at least one solid portion of the support plate faces the opening in the bottom regardless of the angular position of the support plate relative to the bottom.

3. Box according to claim 1, further comprising means for angularly positioning the support plate relative to the bottom.

4. Box according to claim 3, wherein the angular positioning means comprise complementary surfaces of the support plate and the side panel.

5. Box according to claim 1, wherein at least one solid portion of the support plate faces the whole of the opening in the bottom.

6. Box according to claim 1, wherein the support plate includes a plurality of holes.

7. Box according to claim 6, wherein the holes in the plate are different sizes.

8. Box according to claim 2, wherein at least one solid portion of the support plate faces the whole of the opening in the bottom.

9. Box according to claim 3, wherein at least one solid portion of the support plate faces the whole of the opening in the bottom.

10. Box according to claim 4, wherein at least one solid portion of the support plate faces the whole of the opening in the bottom.

11. Box according to claim 2, wherein the support plate includes a plurality of holes.

12. Box according to claim 3, wherein the support plate includes a plurality of holes.

13. Box according to claim 4, wherein the support plate includes a plurality of holes.

14. Box according to claim 5, wherein the support plate includes a plurality of holes.

15. Box according to claim 8, wherein the support plate includes a plurality of holes.

16. Box according to claim 9, wherein the support plate includes a plurality of holes.

17. Box according to claim 10, wherein the support plate includes a plurality of holes.
